(19) United States
(12) Patent Application Publication
(10) Pub. No.: US 2002/0050215 A1
(43) Pub. Date: May 2, 2002

(54) Stamps for faux printing/printing crackle finishes

(76) Inventor: Clifford M. King, Independence, MO (US)

Correspondence Address: WESTMAN, CHAMPLIN & KELLY, P.A., INTERNATIONAL CENTRE - SUITE 1600, 900 SECOND AVENUE SOUTH, MINNEAPOLIS, MN, 55402-3319, US

(21) Appl. No.: 09/903,406

(22) Filed: Jul. 11, 2001

Related U.S. Application Data
(60) Provisional application No. 60/217,374, filed on Jul. 11, 2000.

(51) Int. Cl. B41F 17/00

(52) U.S. Cl. 101/41

(57) ABSTRACT

A crackle finish for a wall or other object is obtained by utilizing a pad that has a number of small ribs on one side. The ribs terminate along a common plane, and will be made of a material that can receive paint, ink or other printable substances. The pad ribs are oriented so that each time the pad is pressed against the surface in a printing or stamping operation, it will leave an image that can be mated with the next image using the same or different pads to provide an overall finish that represents a crackle paint surface.

### CROSS REFERENCE TO RELATED APPLICATION

The present application is based on and claims the priority benefit of U.S. provisional patent application Ser. No. 60/217,374, filed Jul. 11, 2000, for STAMPS FOR FAUX PRINTING/PRINTING CRACKLE FINISHES; reference is also made to copending Design application Ser. No. 29/126,336, filed Jul. 11, 2001 for STAMPING PAD DESIGN FOR DECORATIVE FINISHES USING INTERFITTING REPEATING DESIGNS, and to Design application Ser. No. 29/126,219, filed Jul. 11, 2000, for CRACKLE STAMP PAD DESIGN FOR PRINTING REPEATED DESIGNS ON SURFACES.

### BACKGROUND OF THE INVENTION

The present invention relates to a series of “crackle” stamps or pad for decorative painting or printing designs onto a substrate, such as a wallpaper or other surface, which essentially is the same as an art form called faux painting. The stamps or pads disclosed are hand held pads that have various patterns by narrow, form raised ribs for producing a “crackle” finish look on the finished substrate surface and can be used with paints, inks, glazes or other desired transferable media.

In recent years the trend toward imitating the finish of such things as wood, marble, leather and granite has increased. This art form is called faux painting. Faux painting originally meant imitating something that is real. Faux is a French word meaning fake. Faux painting has expanded to cover a much broader spectrum of decorating such as sponge painting, rag rolling, and using paper or plastic sheets placed on walls and pulling the sheets off to make all types of random patterns.

Also included in decorative painting is crackle painting. Crackle painting is not a new process, and in the past it was accomplished by applying glue to a surface, letting it dry, and then painting over it with some type of a paint. The paint would rewet the glue, and then both would dry but at different rates. The paint dried more quickly than the glue, producing a crackle look. More recently paint companies have produced paints that would do the same thing. The crackle effect results because two materials dry at different rates.

This process has been very popular but is difficult to apply in large areas such as a wall. Even with areas as small as a coffee table top it is almost impossible to get a consistent look. Applying the second coat with a spray gun may or may not work satisfactorily, and other difficulties with crackle paints are the limiting of colors and the sheen of the paint.

The process generally is unsatisfactory unless the painter is extremely skilled. Aerosol crackle paints that are available can be used on small items such as picture frames and the like with good results.

The present invention relates to stamps or printing pads that will produce a crackle finish in a consistent and uniform way, and which can be used by a home owner with good results.

### SUMMARY OF THE INVENTION

The present invention relates to a series of hand held supports, as shown, stamps or printing pads that have a backing panel that preferably is flexible, with a series of raised ribs of uniform height, but of different widths and length in shapes and relative direction that appear random, but which are oriented to interfit with sequentially applied images. The end surfaces of the raised ribs line on a common plane and form a stamp or printing pad printing surface plane. The ribs are provided with varying widths, shapes, and directions on the stamp. The shape of the periphery of the stamps or printing pads that are disclosed can be modified, but the shapes are designed so that they can be interfitted with other printed patterns (faux painted crackle patterns) that have been made by the same stamp or printing pad so that a large area can be decoratively painted with a crackle finish. The support can be a roller, if desired.

The painter or decorator is able to control the end results using the crackle stamps with a minimal amount of skill. The printed images are made by directly applying the ribs. Carrying a suitable medium onto the surface and then removing the pad without sliding on the surface. Another advantage of using the stamps or printing pads of the present invention is that discontinuing painting in the middle of a task and then coming back later and completing the job does not affect the finished product. With crackle paints this is impossible because the job must be completed once it is started. The color possibilities with the stamps or printing pads of the present invention are also limitless, because any type of a color paint or ink available can be put onto the stamp or printing pad surfaces of the ribs and then transferred to a wall or other receiving surface.

The pads shown in the accompanying drawings and illustrations will imitate actual crackle patterns. Brush crackle, hairline crackle, standard crackle, large crackles and elongated, lightning bolt like crackles can be provided. Existing prior art methods are limited in colors, and it is difficult to avoid obvious inconsistencies in large areas. Those problems are avoided using the present invention. The patterns that are disclosed available in all colors, and are capable of being interfitted, overlapped, and joined, so that they form a pattern on a wall or a surface that is pleasing to the eye and easily made, and is difficult to identify as repeating. The patterns reproduced can be placed on rollers or larger pads for covering larger areas. The interfitted patterns would repeat when rolled on, but due to the nature of the random shaped ribs, and a combination of different shaped pads, the finish does not appear to have a repeating pattern.

### BRIEF DESCRIPTION OF THE DRAWINGS

FIG. 1 is a top plan view of a stamp or printing pad showing a handle side;

FIG. 2 is a side elevational view of the pad of FIG. 1;

FIG. 3 is a bottom plan view of the stamp pad of FIG. 1 shown in an oblique position;

FIG. 4 is a pattern that is printed or stamped onto a substrate with the stamp pad of FIGS. 1, 2 and 3;

FIG. 5A is an aggregate exploded view of imprints on a surface shown spaced apart but with outlines for illustrating interfitting of individual patterns called standard crackle patterns which are merged for a crackle finish;

FIG. 5B shows the patterns of FIG. 5A interfitting to make a uniform pattern with the illustrative outlines remaining in place;

FIGS. 5-C1 through 5-C4 show exploded views of interfitting representations of the pattern of FIG. 4 sequentially merged together to form the overall crackle finish pattern;

FIG. 5D illustrates a larger crackle finish with the pattern of FIG. 4 with the patterns closely interfitting;

FIG. 5E illustrates a larger crackle finish of the printed pattern of FIG. 5 with the patterns spaced and merged in selected locations;

FIG. 6 is a top plan view of a modified periphery crackle stamp or printing pad made according to the present invention;

FIG. 7 is a side elevational view taken on line 7-7 in FIG. 6;

FIG. 8 is a bottom plan view of the stamp pad of FIG. 6;

FIG. 9 is a view of the pattern of the stamp pad of FIGS. 6 and 8 as stamped onto a substrate;

FIG. 10 is a top plan view of a further modified crackle stamp pad having an irregular curved peripheral edge;

FIG. 11 is a plan view of the rib side of the stamp pad shown in FIG. 10;

FIG. 12 is a view of the pattern of the stamp of FIG. 11 stamped or printed onto a wall or substrate;

FIGS. 13A through 13H are illustrations of printed patterns stamped onto a wall utilizing the stamp or printing pads shown in FIGS. 6 through 12, in various conjunctions to form illustrative configurations;

FIGS. 14A, 14B, 14C and 14D are illustrations of interconnecting of the stamp pads shown in FIG. 9, for example, and the interfitting of printed patterns from modified stamp pad patterns similar to that shown in FIG. 12;

FIG. 15 is a bottom view representation of a further modified crackle printing pattern known as a brush crackle stamp pad showing the ribs used for forming the stamping plane;

FIG. 16 is a representation of a single pattern made using the stamp pad of FIG. 15 on a substrate or wall surface;

FIG. 17 is an exploded view of spaced crackle stamp patterns from the pad shown in FIG. 15 with border lines in place for illustration purposes to show how the patterns can be joined together to make an overall pattern;

FIG. 18 is an assembled pattern made with the representation shown in FIG. 17;

FIGS. 19A, 19B and 19C are illustrations of how the stamp or printing patterns of FIGS. 15 and 16 will fit together on a surface;

FIG. 20 is a representation of a use of the stamp or printing pads of FIG. 15 to make an overall pattern after stamping individual pad footprints adjacent each other;

FIG. 21 is a representation of a pattern with a fit where the finish is varied by spacing the pattern in certain portions and overlapping the patterns in other locations to form a different overall pattern from FIG. 20, with the same stamp pad pattern;

FIG. 22 is a bottom plan view of a stamping or printing surface of a crackle stamp pad used for as a filler pattern;

FIG. 23 is a representation of the pattern made by the pad of FIG. 22 on the surface;

FIG. 24 is a representation of a stamped or faux crackle finish area utilizing the stamp pad of FIG. 15 with gaps shown in the pattern;

FIG. 25 is a view of the printed pattern of FIG. 24 after filling in with the stamp pad of FIG. 22;

FIG. 26 is a plan view of the top or handle side of the stamp pad of FIG. 15;

FIG. 27 is a handle side view of the stamp pad of FIG. 22;

FIGS. 28A, 28B, 28C and 28D are representations of actual patterns on surfaces made with stamp or printing pads shown in FIGS. 29A-29D on surfaces;

FIGS. 29A through 29D are the rib sides of pads used for imprinting the patterns of 28A through 28D, respectively;

FIGS. 30A through 30D are representations of stamped or printed patterns made with the pads shown in FIGS. 29A through 29D;

FIG. 31 is a further representation of a pattern made with the pads of FIGS. 29A through 29D;

FIG. 32 is a side elevational view showing a stamp or printing pad of the invention that is flexed to fit a contour such as a column surface utilizing a stamp pad having handles of the present invention;

FIG. 33 is a further stamp or printing pad made according to the present invention having a different periphery and pattern showing the stamping or printing surface ribs;

FIG. 34 is a representation of the pattern made with the stamp pad of FIG. 33;

FIG. 35 is a representation of a pattern made on a surface utilizing the stamp pad of FIG. 33, which has hairline stamping ribs for a hairline pattern; and

FIG. 36 is a representation similar to that in FIG. 35, except that there has been a double application of the same pattern utilizing the stamp pad of FIG. 33.

### DETAILED DESCRIPTION OF THE ILLUSTRATIVE EMBODIMENTS

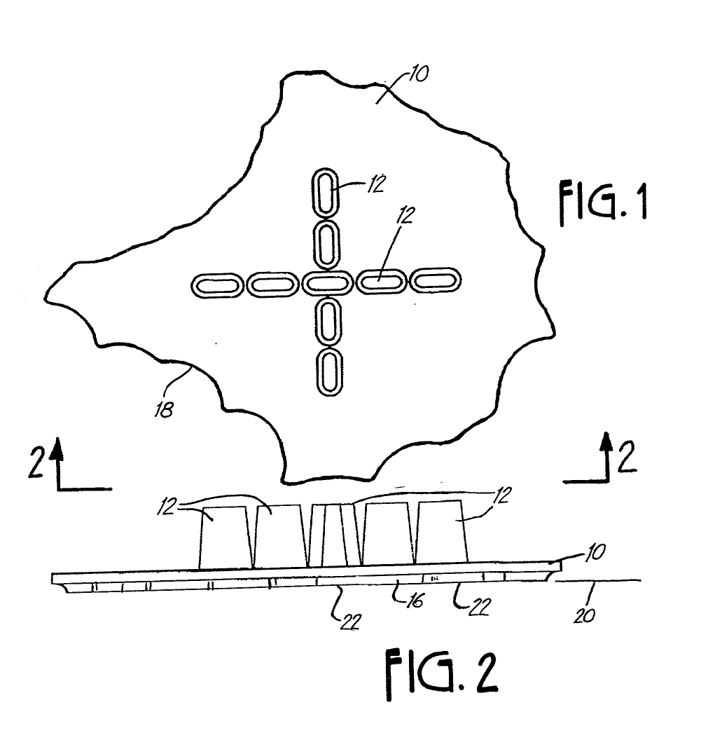

All of the stamp pads illustrated are made in substantially the same manner, and as illustrated in FIG. 1, include a backing wall or panel that is plate like, and indicated generally at 10 that has individual relatively small, but easily gripped handles projecting upwardly from the top indicated at 12. The number of handles 12 and the size and shape of the pad panel can be varied, but they are generally spaced as individual columns, as shown, to permit the panel 10 to flex.

The wall or panel 10 can be made of any desired flexible material, and preferable is made of a synthetic rubber to resist solvents, or of some plastic material that is soft and pliable so that it can bend around columns or curved, convex or concave surfaces. The pattern transferred when painting is determined by the configuration of raised ribs that have outer ends lying on a plane. As that shown in FIG. 3 and other figures, a number of raised, narrow and elongated ribs, that are irregularly shaped and indicated at 16. The shapes can be random, within the peripheral edge 18 of the pad 10.

The ribs have end surfaces 22 shown as dark lines. The end surfaces 22 of the ribs are all at the same level or in other words on a common plane. This plane is indicated by the line 20 in FIG. 2, for example. The ribs form a stamp pad or paint pad surface that can be placed onto an ink pad for loading, or the ends covered with a paint or ink, or the paint or ink can be applied to the end surfaces with a roller, or sponge with a glaze applicator and the like. The exposed end surfaces 22 of these rib-like members 16 are kept narrow but they will hold some paint or ink without letting it run off excessively. When the pattern is stamped in place the image will remain to decorate the surface on which it is applied.

The pad wall or plate such as that shown in FIG. 1 may have a maximum dimension in the range of 5 inches, with a width of about 4 inches. The ends of the ribs on plane 20 can range in width from under 1/64 of an inch for hairline cracks to 1/4 of an inch or more if a large crack is simulated. Usually the ribs are preferably about 1/8 inch in width or less. The length can be short or long as desired. The ribs have a height of about 1/8 inch. The ribs are self sustaining, or in other words, do not deflect laterally under stamping loads.

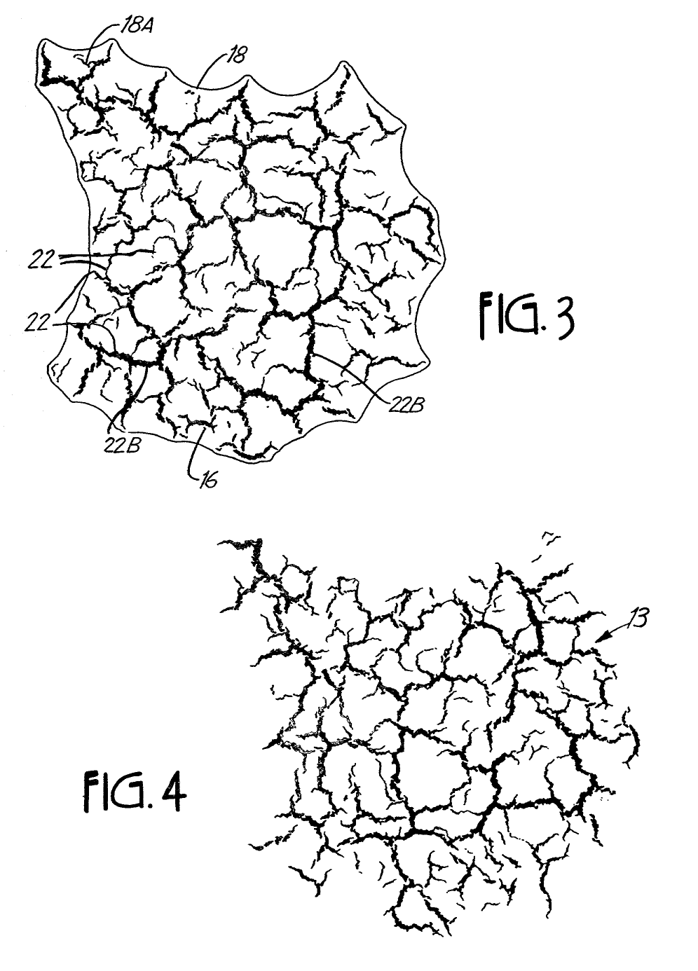

The material that is used for the pad wall is usually a material that is receptive to ink or paint and is flexible so that it can bend around the columns, or other concave or convex surfaces. The shape shown in FIG. 3 has a peripheral edge shape with a number of concave portions, and blunt peaks or convex portions in the periphery, along with one projection out near an end indicated at 18A. The ends 22 of the ribs 16, as shown, vary in thickness. For example, very thin (under 1/64 inch) rib sections 22A are shown, as well as the wider portions 22B (about 1/16 to 1/8 inch) that have a more substantial width surface. A standard pattern as shown in FIG. 3, and as imprinted on a surface in FIG. 4 imitates paints that have been rolled on or sprayed on a surface, and as it weathers. The images 22, 22A and 22B from the ribs 16 represent crackles when they are first applied, and the drying process is not relied on for getting additional cracks. Thus, the stamping or directly applied printing (press on and remove without sliding) is substantially easier than with existing procedures which involve the requirement for having two different kinds of paint that dry at different rates so that they will crack or crackle.

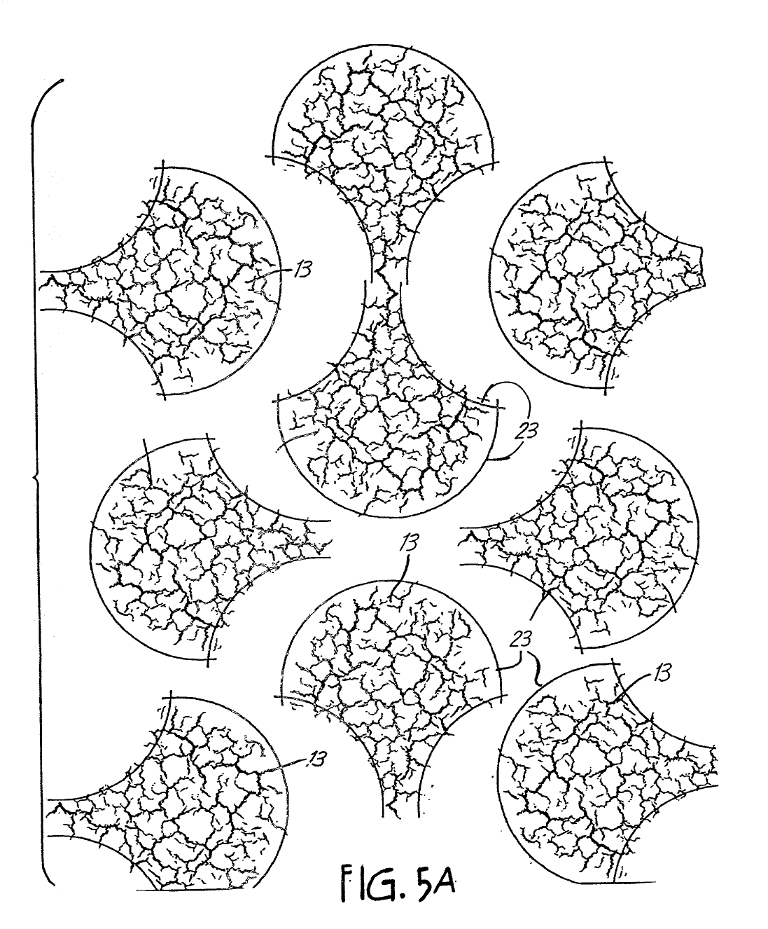

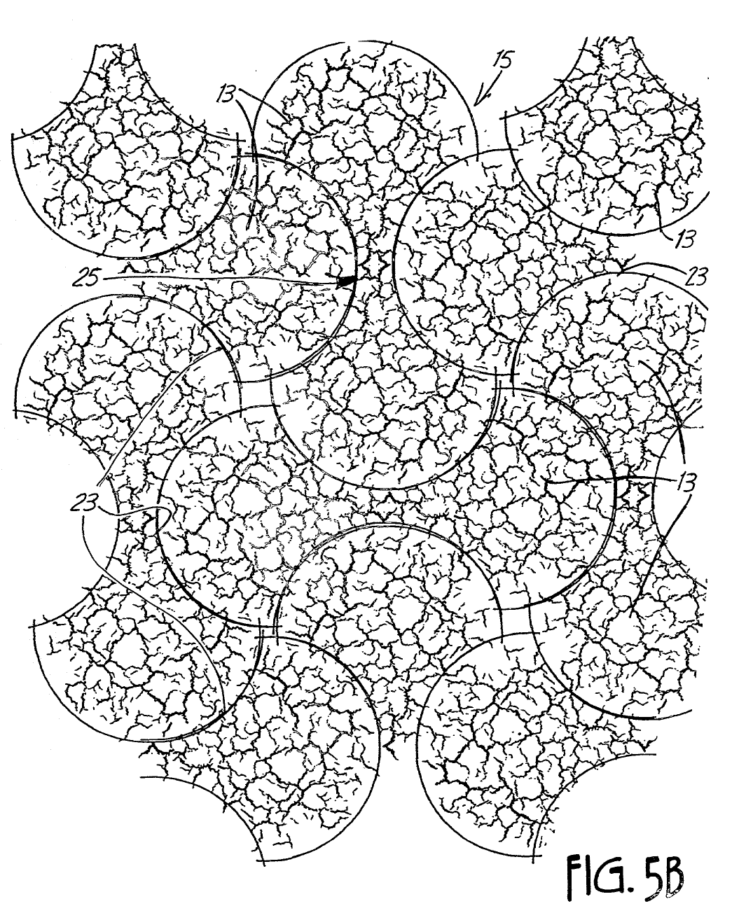

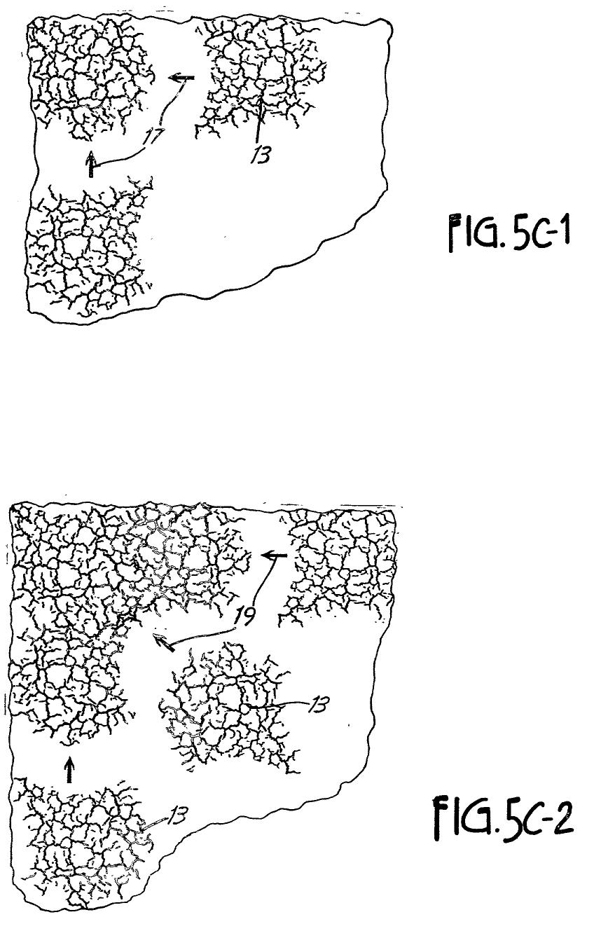

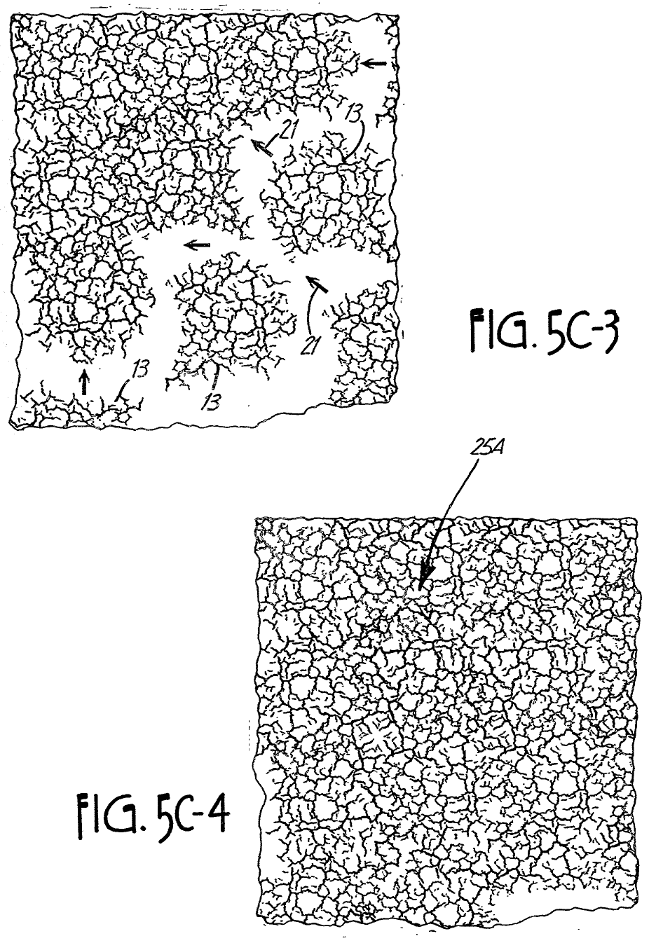

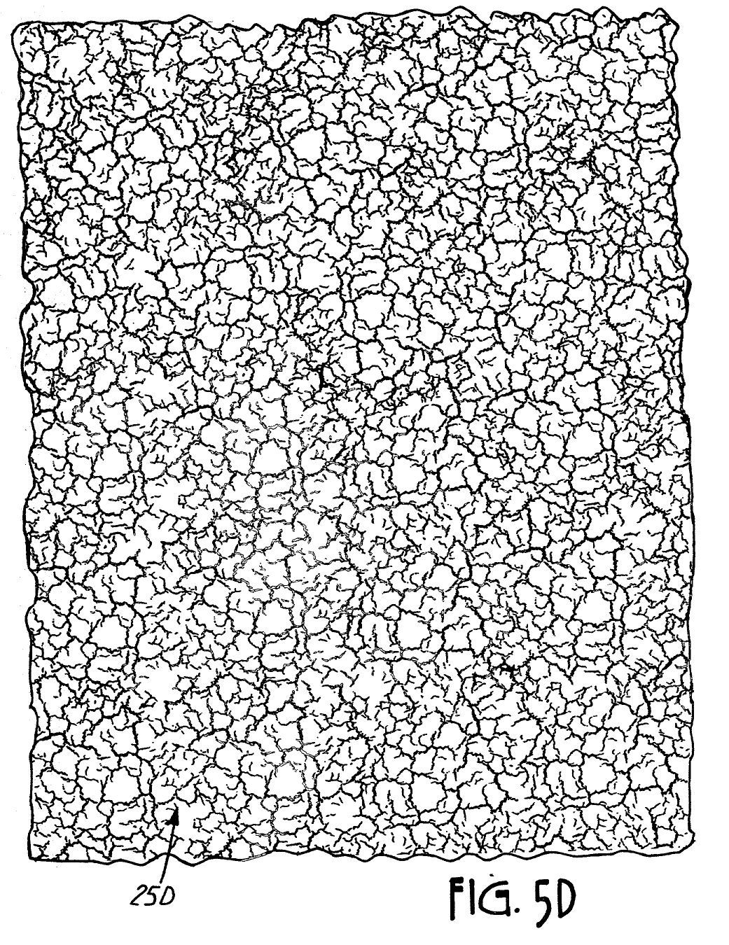

The pattern produced is shown at 13 in FIGS. 5A-5E. In FIG. 5A several patterns 13 are shown exploded and bounded with lines 23 to illustrate how the individual patterns interfit. The patterns can be printed on the wall surface or other surface in several orientations as shown. The jigsaw puzzle shapes of FIG. 5A have the bounding lines 23 for aiding in visualizing how they fit together.

FIG. 5B illustrates an assembly 15 of the individual patterns 13 with the bounding lines fitted together, and a crackle finish pattern being developed.

The orientations of the standard crackle pattern shown with the pad of FIG. 3 in their general outline are made so that they will interfit with the individual rib pattern overlapping, and in some cases joining the ribs of other patterns as generally shown in FIG. 5B, where the outline shapes or lines 23 are mating with other lines 23 of other patterns.

For example, in the region shown generally at 25, the patterns are made so that two of the patterns are moved up with the narrow ends together, and then the rounded, wider patterns fitted into the “neck” portion that is at the end of the arrow 25 in FIG. 5B.

It can be seen that when the patterns are placed as shown, there is no distinction between the stopping of one pattern and the start of another, so that the pads can be oriented and lined up and then stamped against the surface with the results of an irregularly shaped crackle pattern.

In FIG. 5C-1, the individual patterns 13 without the boundary lines 23 are shown being moved together by arrows 17, to simulate building a pattern and thus ones which grow as shown in FIG. 5C-2, where additional patterns 13 are moved (before printing) as indicated by the arrows 19 into the previously formed crackle pattern assembly.

FIG. 5C-3 shows more patterns 13 that can be moved together as indicated by the arrows 21 to form a final overall pattern shown at 25A in FIG. 5C-4 where the individual crackle finish patterns are printed in place on a surface area. The eye can not distinguish the boundaries of the individual printed patterns.

The patterns will be aligned for interfitting before stamping the stamp or printing pad onto the surface.

FIG. 5D shows an overall pattern 25D made similar to that shown in FIG. 5C-4 in an enlarged view to show a tight fit of the patterns.

FIG. 5E shows a print of a more spaced interfitting of the patterns forming more openings 25B in the pattern, utilizing the patterns 13.

Additionally, an overlay of 2 or more patterns creates a dense crackle pattern 25C in selected regions.

In FIG. 5D the representation is after applying the stamp pattern for the standard pad in a casual way. The irregular peripheral lines of the rib patterns make it possible to get a printed pattern that looks realistic, where a square or rectangular pad does not provide the same image. The attempt to make perfect fits out of the stamp pads will many times result in a configuration that is not as pleasing as the random application of an irregular periphery pad as shown in FIG. 5D.

FIG. 5E, shows a looser fit of patterns, which leaves some void areas, such as that shown in regions 25B. These void areas add to the overall appearance, which makes the crackle finish appear realistic. Additionally, a region shown at 25C is a region where there has been deliberate overlap of the patterns to make the lines left on the crackle finish more dense, which also blends in with the white areas. Control of the final results by the user, can provide for many different patterns utilizing individual stamp pads that cover only a portion of the area of a wall surface, and which can be overlapped or left with void openings as shown.

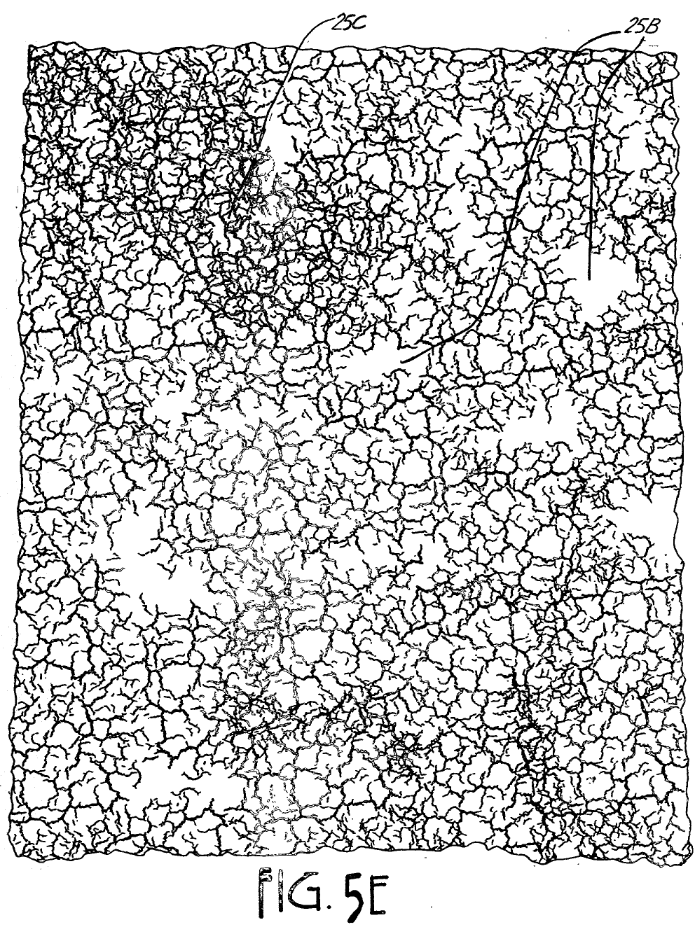

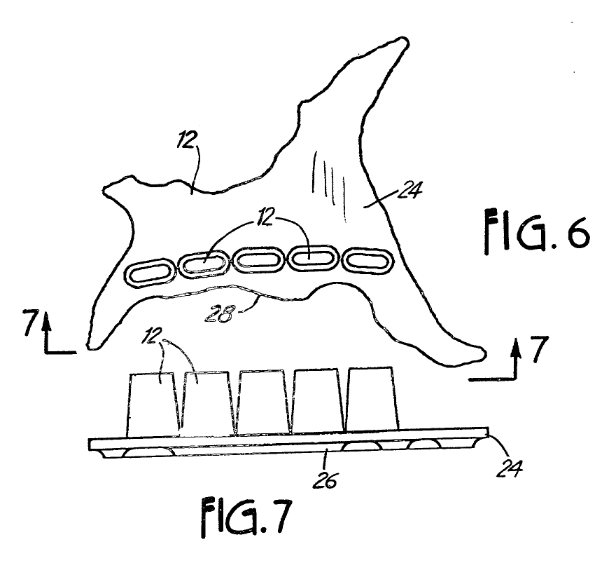

FIGS. 6 and 7 show a pad 24 having a different peripheral shape. The pad 24 comprises a wall or panel with handles 12 shown in FIG. 1. The pad 24 has lower projecting ribs 26 that are illustrated in FIGS. 8 and 9. The ribs can be of different widths, lengths and configurations or patterns or shape. The periphery 28 of the stamp pad 24 can be in this case called a “California crackle” shape, or California crackle pad.

The pattern shown at 30 (FIG. 9) has been applied to a surface, by using the pad 24, and represents the printing of a pattern with the depending rib members 26. The ribs are wider, and range to 1/4 inch or greater for effect.

In FIG. 10, a different periphery pad 38 is provided with more shallow edge recesses or concave sections 39A, which are all part of a deep longitudinal concave portion 39B that extends from point 39C to point 39D at one side. The pattern is shown in FIG. 11 with raised stamping ribs 40 of the same height, so that the ribs 40 can take a coating of paint, glaze or ink, and provide a pattern such as that shown at 42 in FIG. 12. The ribs 40 are wider in many portions but also narrow at regions 40A, which are similar to very fine or hairline cracks. The concave recess 39B is used for interfitting patterns.

Each of the Figures in 13A through 13H represent imprints that are made with the California crackle stamps of FIGS. 6 and 10 that are slightly overlapped. The California crackle stamps of FIGS. 6 and 10 can be made with wide and also narrow ribs for receiving paint for making the patterns.

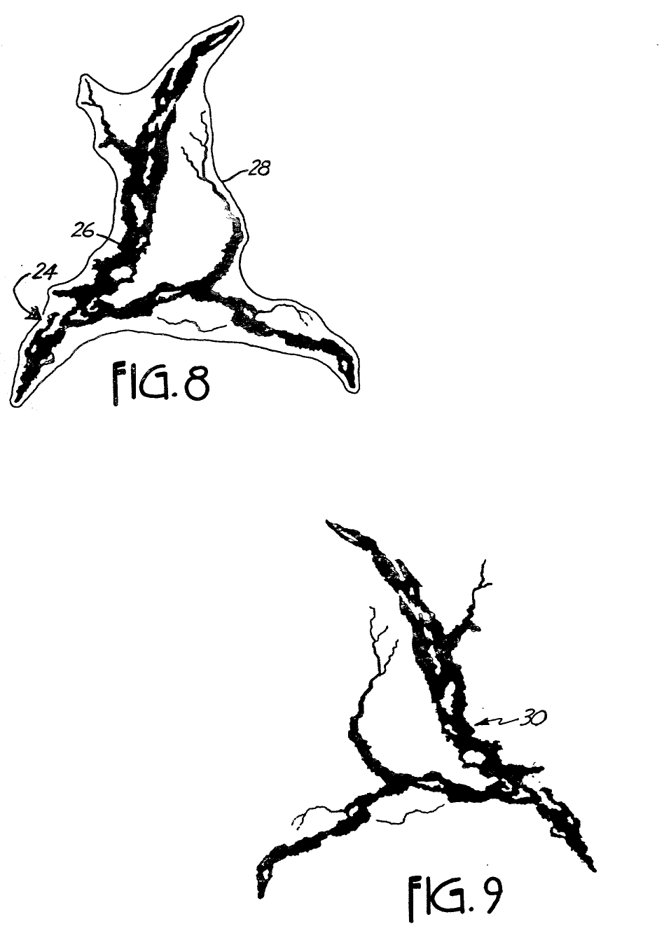

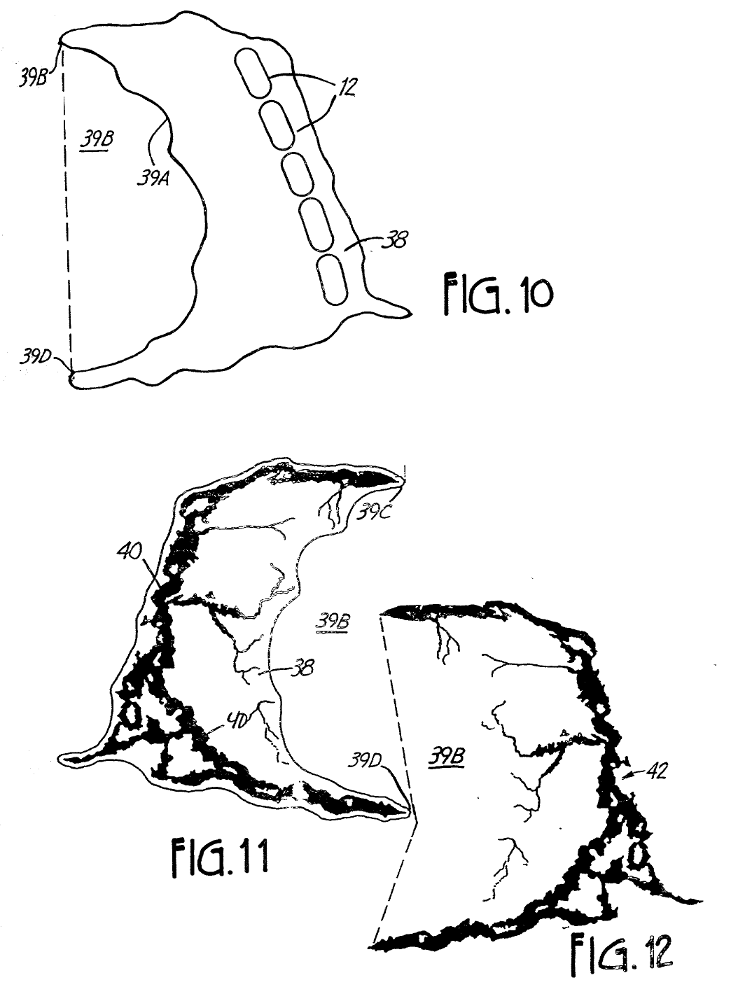

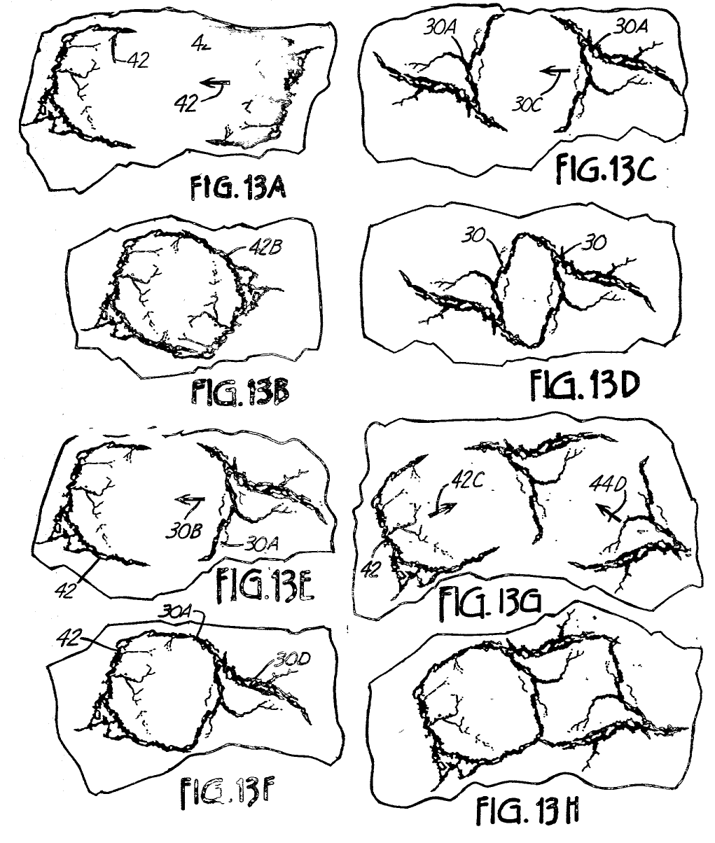

In FIG. 13A is an exploded view showing two patterns 42 facing each other to be interfitted together as shown by the arrow 42A. They form the configuration shown at 42B in FIG. 13B. It has a more open center with narrow lines in the center.

In FIGS. 13C and 13D, the patterns 30A are shown as a mirror image of pattern 30 of FIG. 9, again facing each other and merging together. FIG. 13D shows these patterns merged together after having been moved together as illustrated by the arrow 30E. This forms an open center pattern with narrow lines, and “tails” to each side.

In FIG. 13E, the pattern 42 and the mirror image of pattern 30A are to be merged together by moving the second to print pad in the direction that is indicated by the arrow 30B for stamping. In FIG. 13F these patterns are merged together to provide one side with the tail portion 30B, and the other side with just the crackle pattern 42 joining the ends of the mirror image of pattern 30.

In FIG. 13G, there are two of the mirror image patterns 30A oriented in different directions, joined with the pattern 42 as indicated by the arrows 42C and 42D. This then forms the configuration shown in FIG. 13H, that again provides for a pattern that imitates plaster that has cracked, as well as some types of marble and similar building materials. A California crackle stamp can be made easily with different shaped ribs for obtaining different results, but the images in FIGS. 13A-13H use different patterns to represent a different crackle finish.

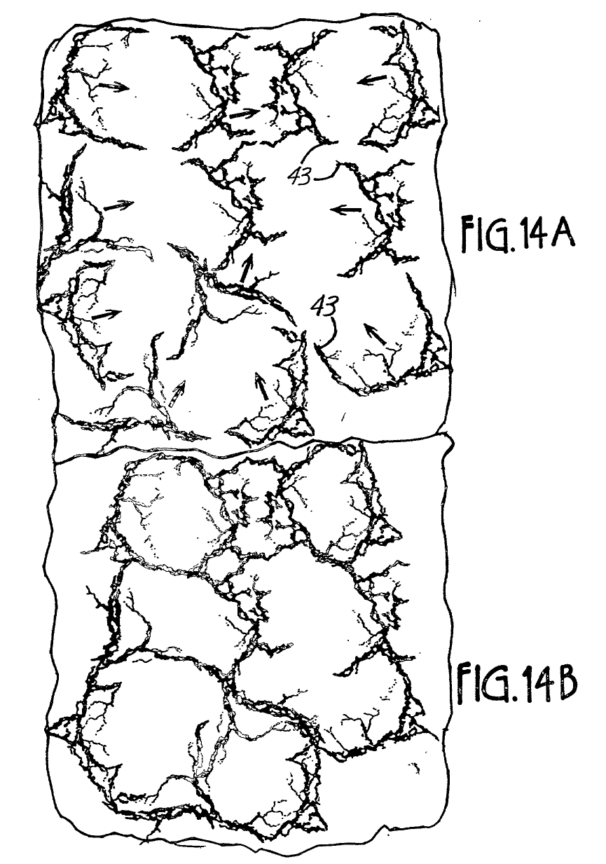

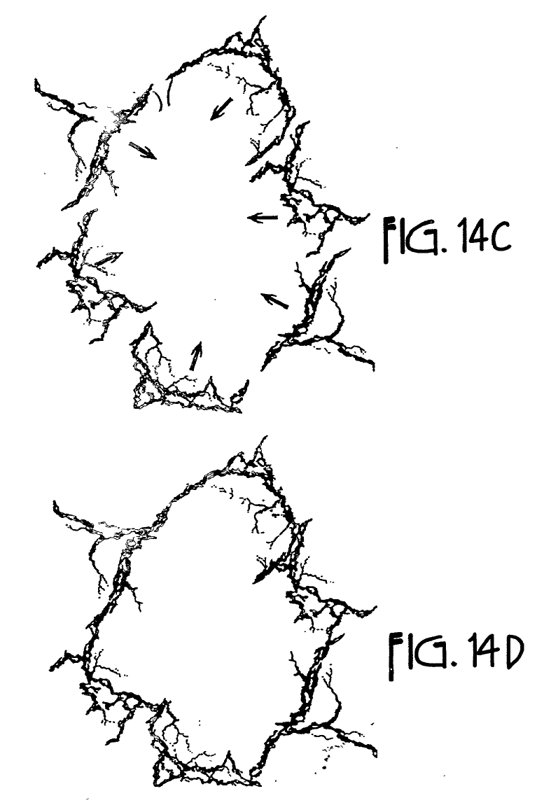

FIGS. 14A through 14D show various representations of these patterns to connect the parts together, with arrows indicating the general movement of the individual patterns. The connections of the points of the patterns, that are illustrated, for example, at 43 is so that they will not show the individual patterns that are joined together. The joining is shown in FIGS. 14B and 14D of the patterns illustrated in FIGS. 14A and 14C, respectively. Each closed area has a different look and a different size, and in FIG. 14C, the formation of stamps that are provided will make a larger loop than that shown in FIG. 14B. Thus, the open area shown in FIG. 14B is obtained by joining the points at different locations and keeping the center portions open.

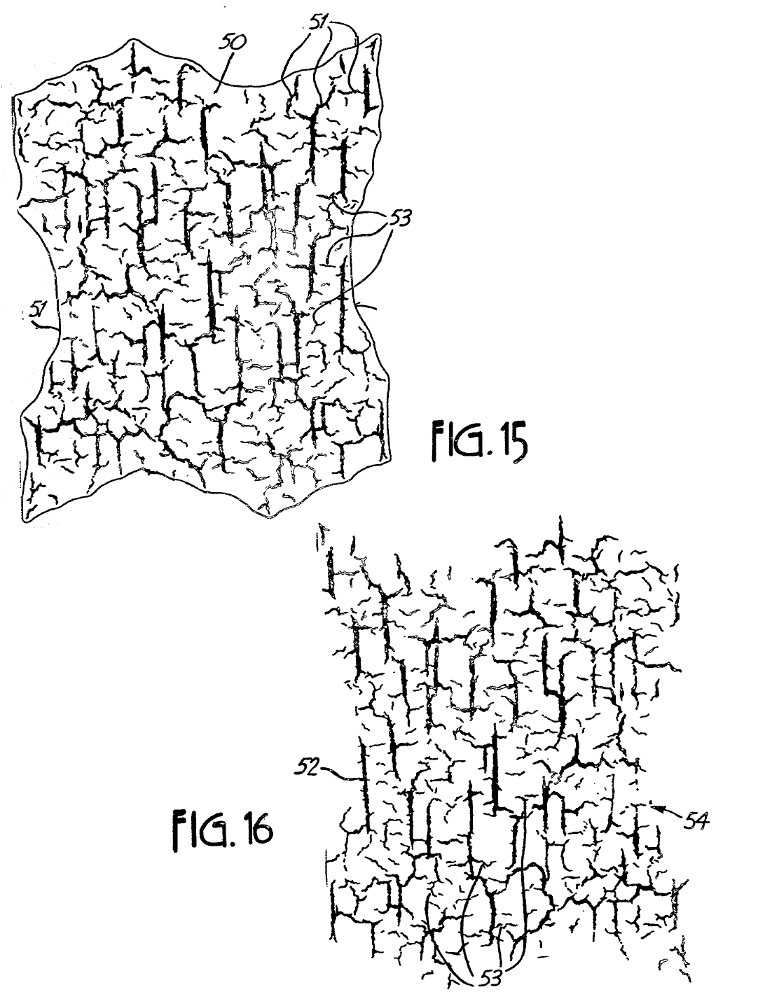

The stamp or printing pad shown at 50 in FIG. 15 has a different peripheral and rib configuration. Pad 50 has main stamping ribs 52 that are oriented so the lengths extend in one direction, with narrower laterally extending fingers 53, that are narrower than the main ribs, to arrive at a stamp pattern 54 shown in FIG. 16. The main ribs may be 1/16 to 18/ inches wide and extend longitudinally for about an inch.

The pattern 53 is indicated as a type of a brush crackle pattern. Oil or water based paints, as well as glazes and inks can be used with this pad as well. The paint or ink material is applied to the pad rib surfaces with a roller or sponge preferably.

The pad 50 as a peripheral edge that has concave portions 51, as well as peak portions, and while the four corners form a shape that is generally rectangular. The pad is not truly rectangular with straight sides, but has concavities 51 so that the interfitting of the patterns 54 can be made more realistic.

Generally speaking, a brush crackle under the prior art processes is formed when paint is brushed on a surface leaving streaks, with weaker areas. As the paint ages, the tendency is to crack in the direction that the paint was brushed. Also if it is brushed on wood it is more likely to crack in the direction of the wood grain. Usually when wood is painted it is brushed in the direction of the wood grain, thus increasing the likelihood of generally cracking in that direction. The pad 50 easily simulates that pattern that effect was achieved only at great effort with painting procedures of the prior art.

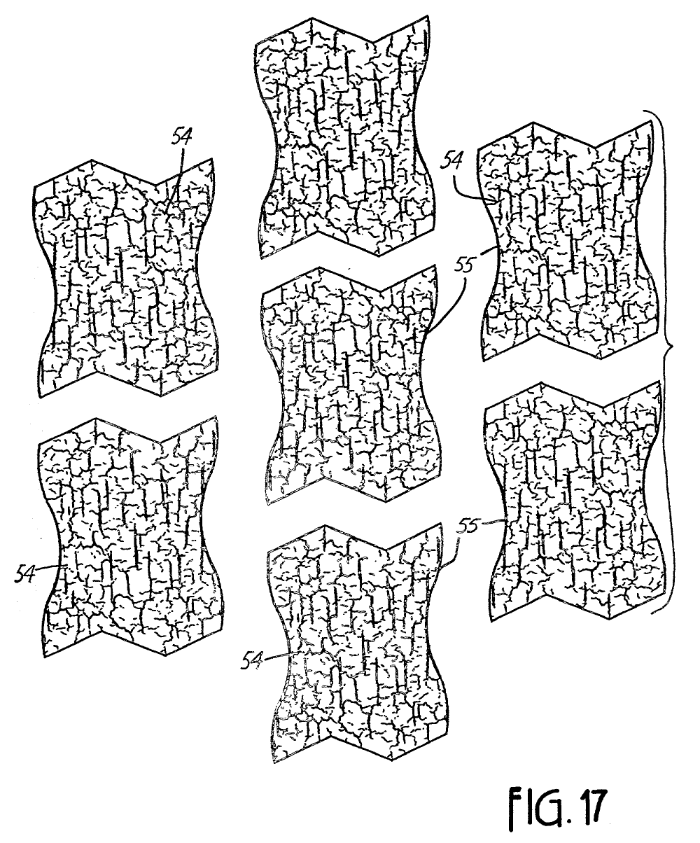

In FIG. 17, the exploded view illustrates the way these patterns 54 can be fitted together. The pattern would be applied in position adjacent or overlapping each other, without sliding them together.

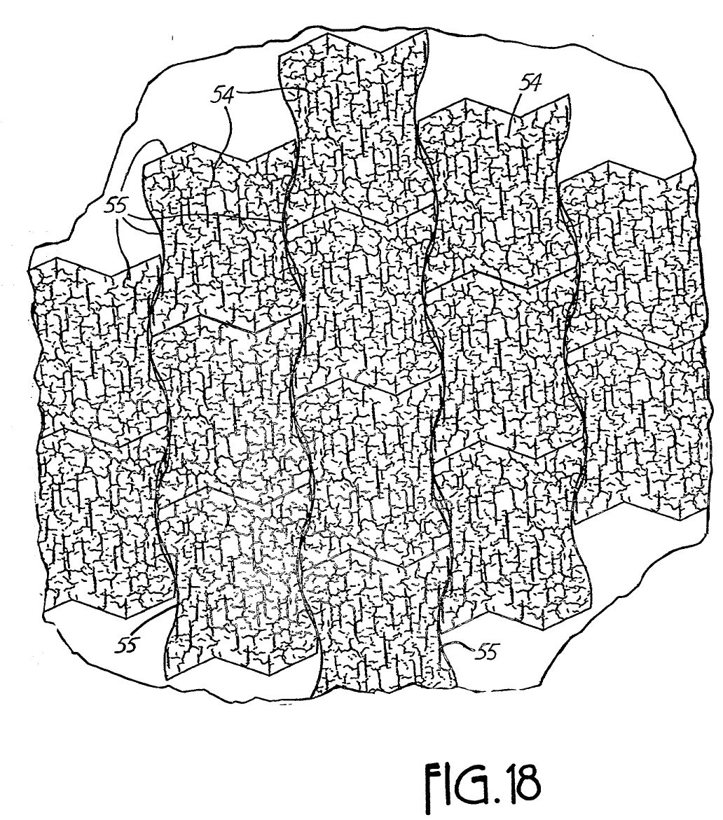

In FIG. 18, the dividing lines that are also illustrated at 55 in FIG. 17, show how the patterns 54 go together, to form an overall pattern. The lines joining the individual patterns are for illustration only.

It should be noted that part of the crackle pattern can be removed adjacent the outer edges of the pad itself, so that when the tools are overlapped the crackle pattern will not be as dense. In other words the crackle pattern can start inwardly from the outer edge of the pad. This is also done with both the standard crackle and the hairline crackle tools.

The wavy sides (with concave portions) and the sawtooth ends (also with concavities) of the pad 50 are designed to help avoid a dense pattern when the printed image is placed side by side and end to end with previously printed images. Thus, the crackle lines or ribs around the peripheral edges of the pad 50 are reduced in order to obtain a satisfactory appearance. If the ends of all the ribs are moved back from the outer edge in the range of a quarter of an inch or so, then the pads can be overlapped on the previous pattern without adversely affecting the look of the pattern.

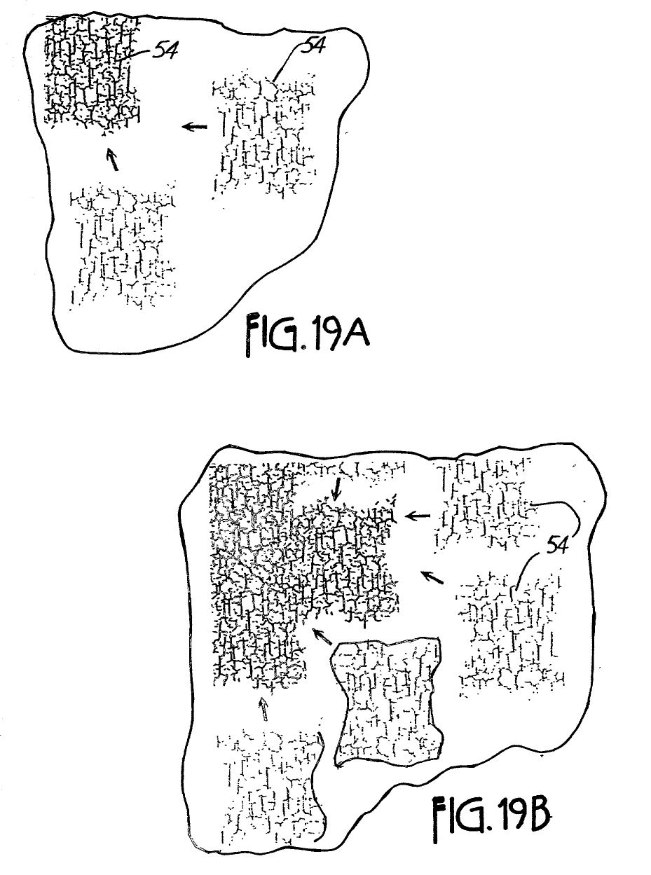

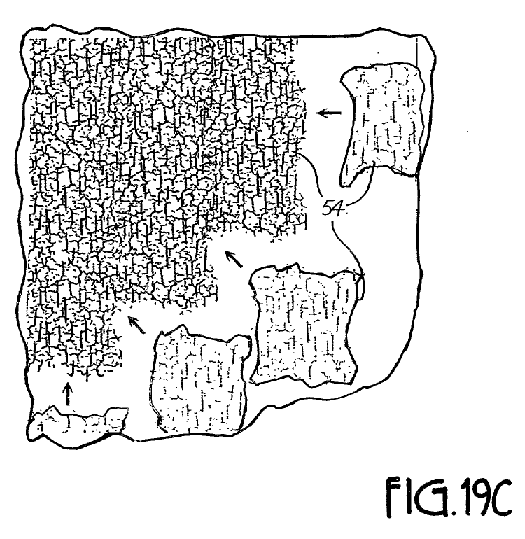

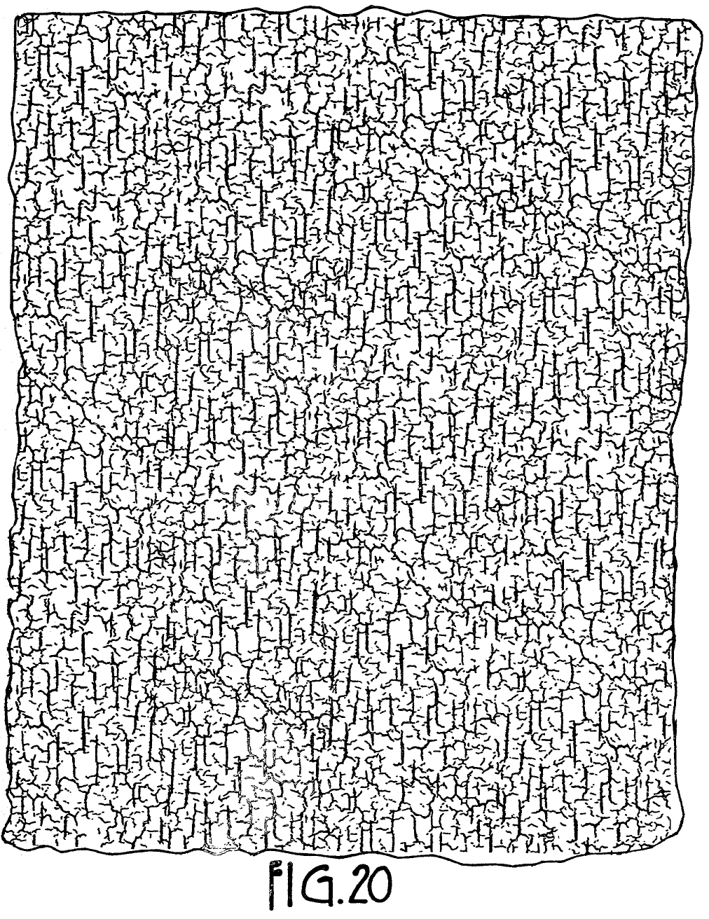

FIGS. 19A-19C and FIG. 20 show that use of the interfitting of the patterns for perfect interlock. The lines around the pads are shown for illustrative purposes, and the wall panels of the stamps or pads tend to overlap slightly. The sawtooth ends and the different sides make each row staggered with the previous row, for obtaining a more pleasing look. When the convex end portions are fitted into the concave center portions of the sides, the patterns appear to be a natural pattern. Exact coordination or precise positioning is not necessary, because the actual crackle forms are not uniform.

The showing in FIG. 20 is the stamp pattern called the “brush crackle” stamp overlapping approximately a quarter of an inch, and it can be seen that is not a factor and cannot be discerned in the illustration of FIG. 20.

In FIG. 21, the same stamp pad that is shown at FIG. 20 is utilized, but by fitting the parts carefully in certain areas, and at other times deliberately leaving an open area, such as that shown at 55B, the final project has a very natural look and can be made as desired.

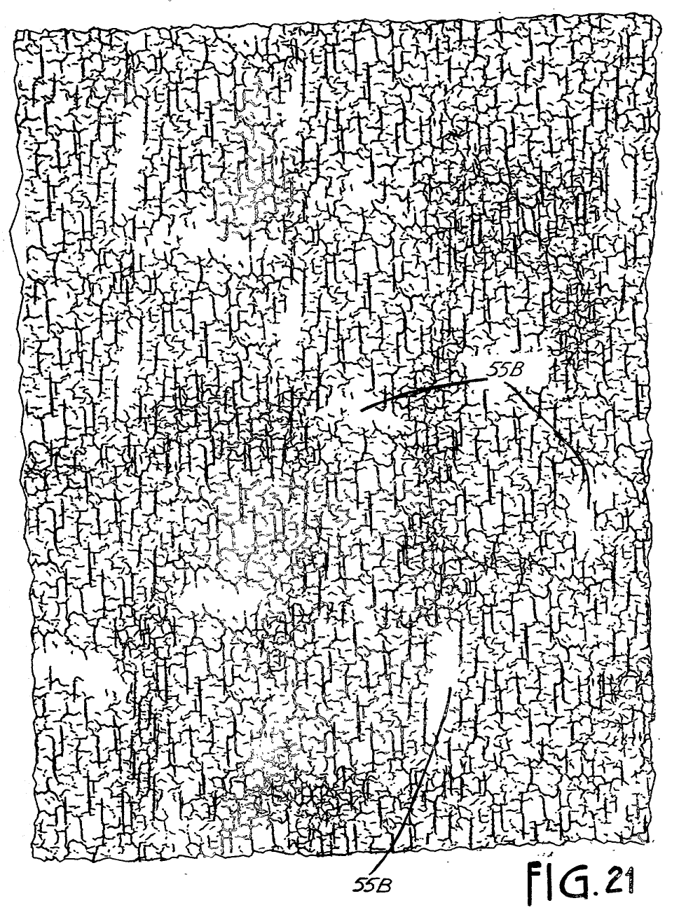

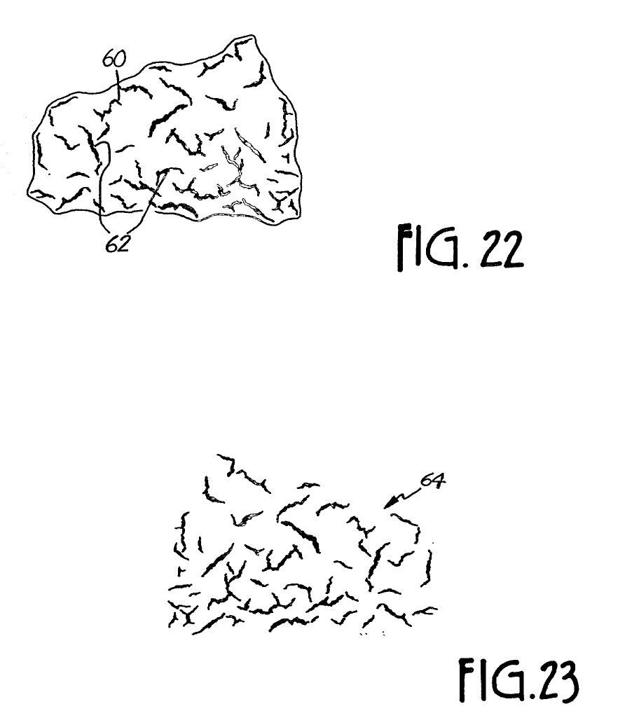

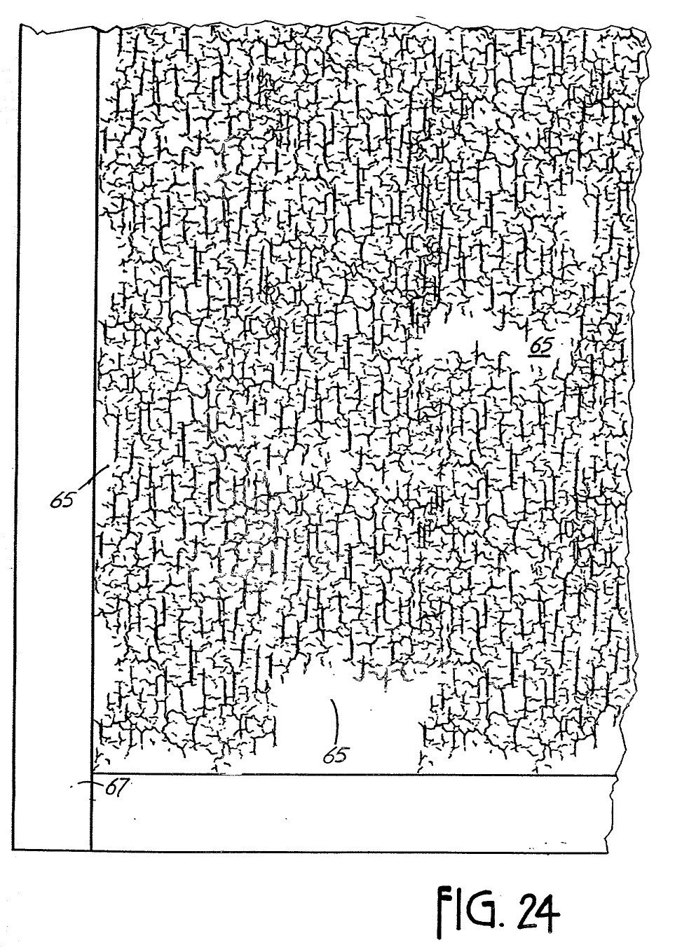

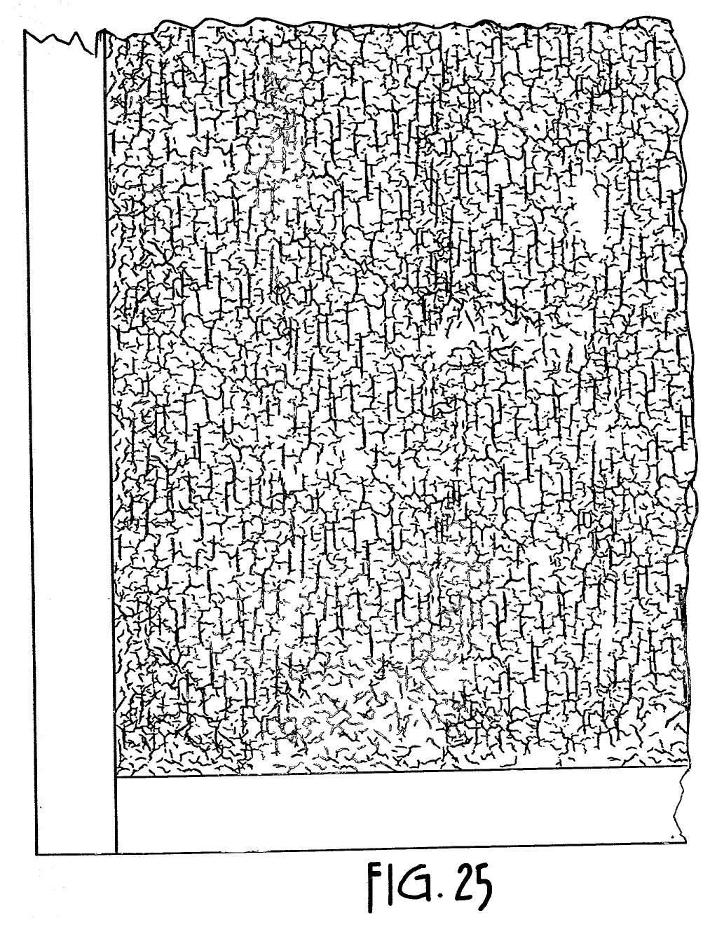

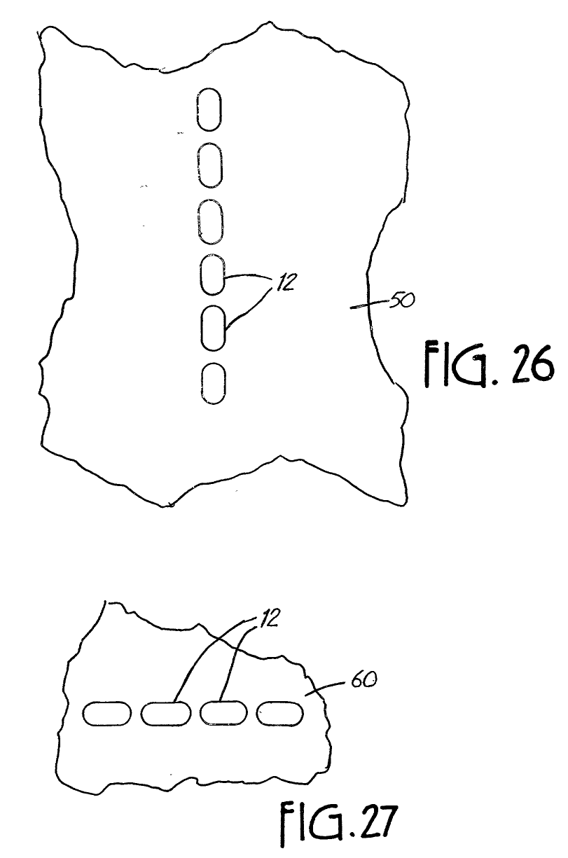

FIG. 22 shows the bottom or rib side of a smaller stamp pad 60 that has a pad panel or was as before with raised ribs 62 that form a particular pattern that provide the imprint or paint pattern shown at 64 in FIG. 23. It is a filler stamp pad which can be used for filling in spaces, such as those which are shown at 65 in FIG. 24, with the brush crackle stamp pad of FIG. 15. FIG. 25 shows the pattern after having been filled in with filler stamp 60.

When the brush crackle stamp pad shown at FIG. 15 is used next to an object such as door trim, the FIG. 24 results can be obtained. The smaller spaces 65 adjacent the door trim that is shown at 67 can be filled in with the small pad. Also, in large areas, the blank regions along edges, or in the center, can be filled in by the filler stamp 60. As shown in FIG. 25, the use of the filler stamp to fill in those voids solves any problem that may occur in the eye of the viewer.

FIG. 26 shows the handles 12, on the brush crackle stamp pad 50. Handles 12 arranged in a different pattern on the smaller filler stamp 60.

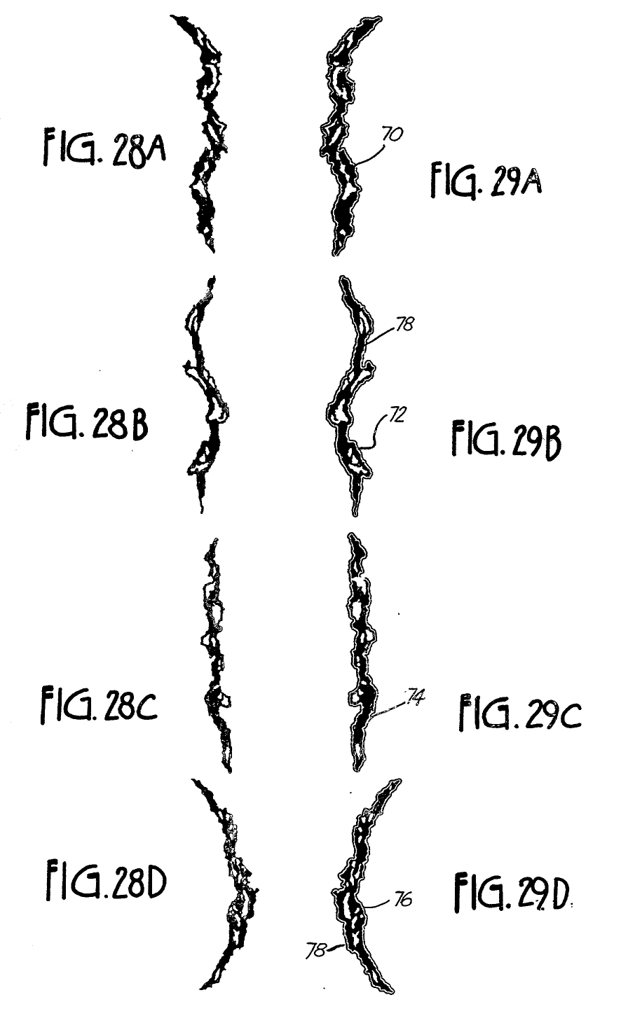

The lightning crackle patterns or images in FIGS. 28A through 28D are created with the stamp pads 70, 72, 74 and 76 shown in FIGS. 29A through 29D respectively. These stamp pads have raised ribs taking up most of the part of the stamp pad, and shown at 78. The widths for the main ribs is greater, in the range of 1/8 to 1/4 inch. Branch narrower and hairline crack ribs can be provided.

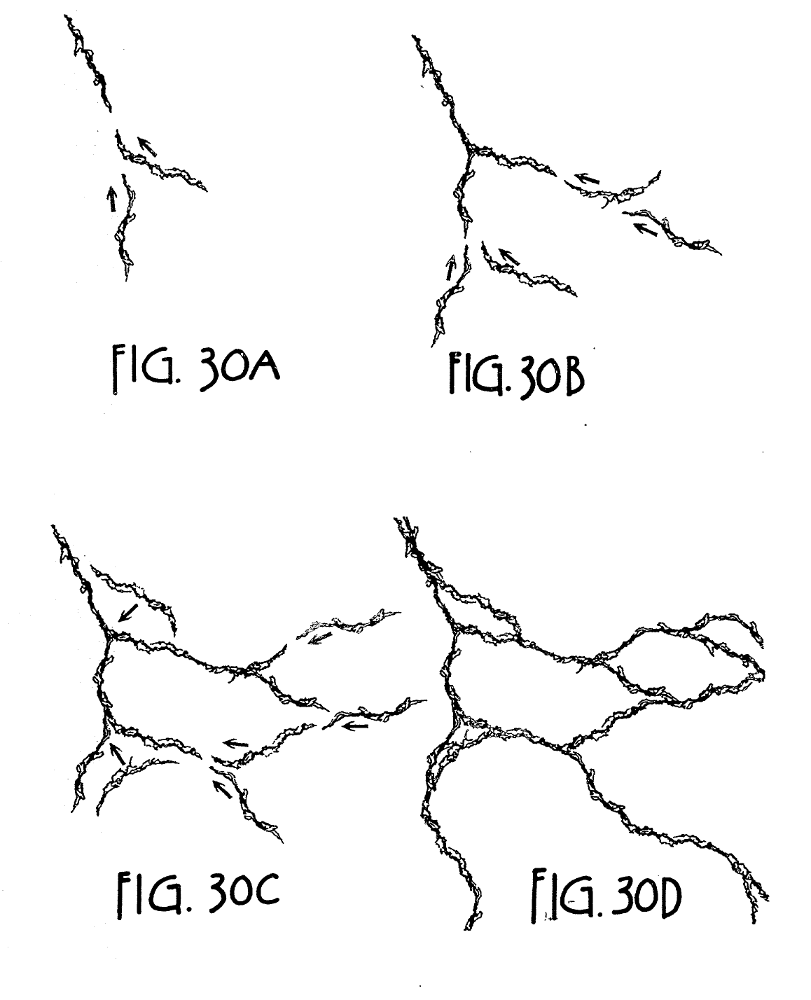

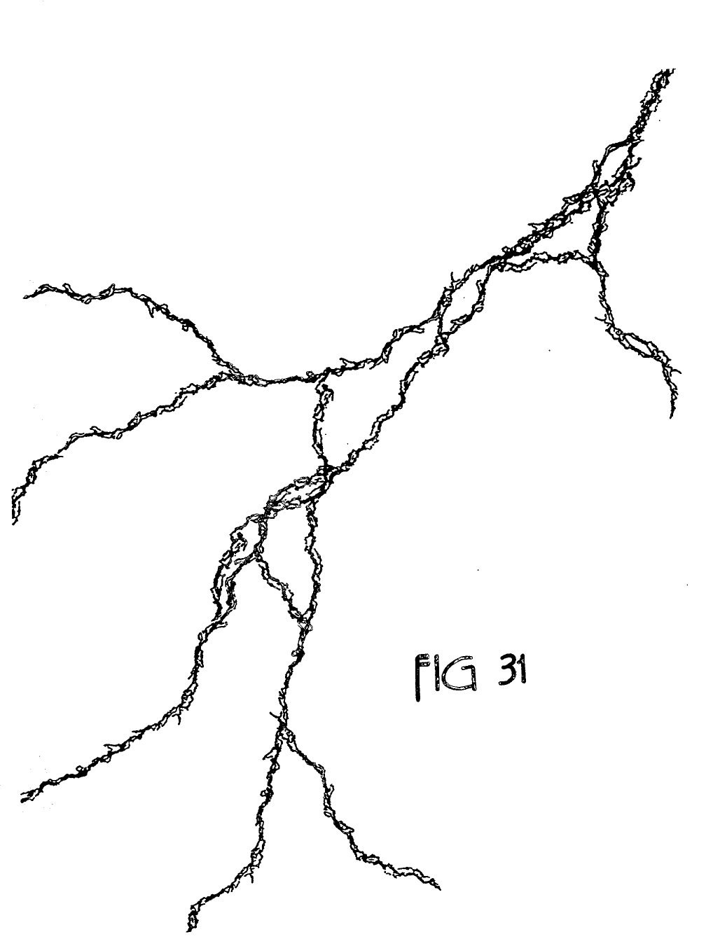

The bottom side of the crackle stamps 70, 72, 74 and 76 that produces this type of an imprint shown in FIGS. 29A-29D are correlated to FIGS. 28A-28D. Again, these stamp or printing pads can be made of a soft rubber material that will bend around columns, and the principal use of this type of an elongated pad is the same as the California crackle. The points are connected to form long cracks like one would find in a sidewalk that is cracked. Plaster walls that are cracked and marble veining also can be made with these stamp pads. The stamp pads themselves would be approximately 3 inches long, and examples of use of these stamps in various configurations as the stamps are used to progress a pattern are shown in FIGS. 30A-30D. FIGS. 30A shows three of the patterns moving together as indicated by the arrows, and the portion indicated at 77A in FIG. 30B shows the sections in FIG. 30A joined together while additional sections are shown in position to be moved as indicated by the arrows in FIG. 30B. The portions 77B in FIG. 30C have been joined together, and additional individual patterns will be moved to join as indicated by the arrows in FIG. 30C. These join and form the pattern shown at 79 in FIG. 30D, with large open areas and tightly configured cracks formed.

FIG. 31 illustrates a pattern that is usually made with feathers by faux painters or with an artist's brush. The results of using a feather are not good, but as shown in FIG. 1, using the stamps in the present invention, a very realistic configuration is provided.

FIG. 32 shows the handles 12 represented for all tools. Small handles 12 are used on the lightning crackle stamp or the narrow stamp as well, and permit flexing of the pad wall.

The handles 12 that are shown in FIG. 32, will separate as the panel 84 of the pad is bent as shown. The panel 84 and the raised ribs 86, are illustrated. The panel 84 can be flexible rubber, so that it can fit around columns or the like, as shown.

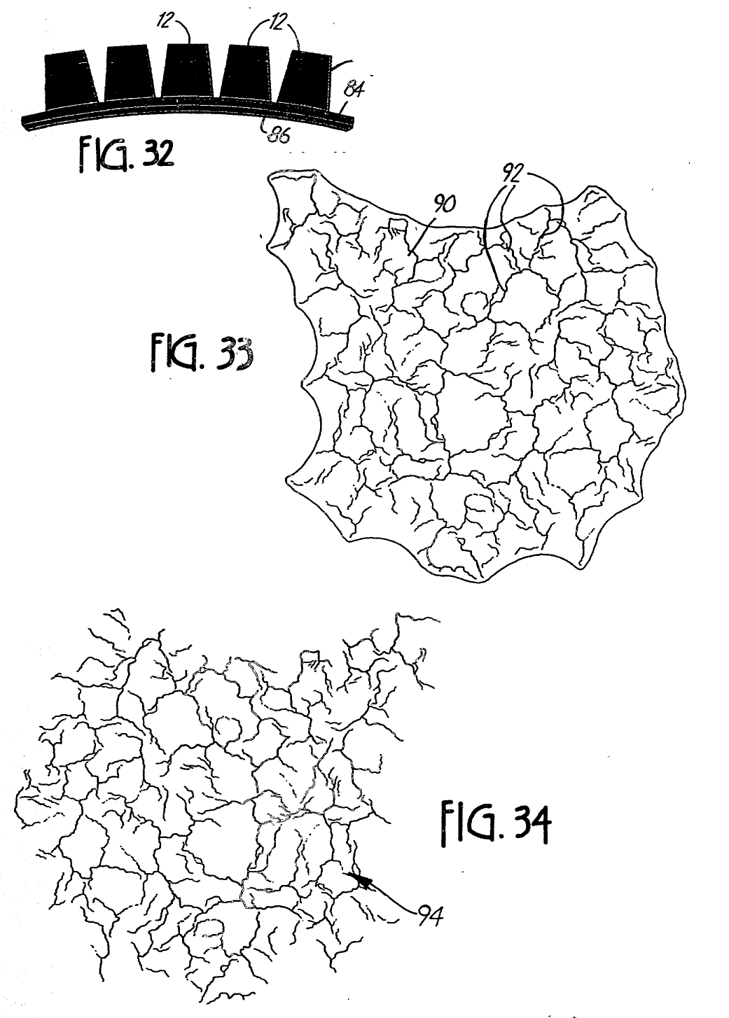

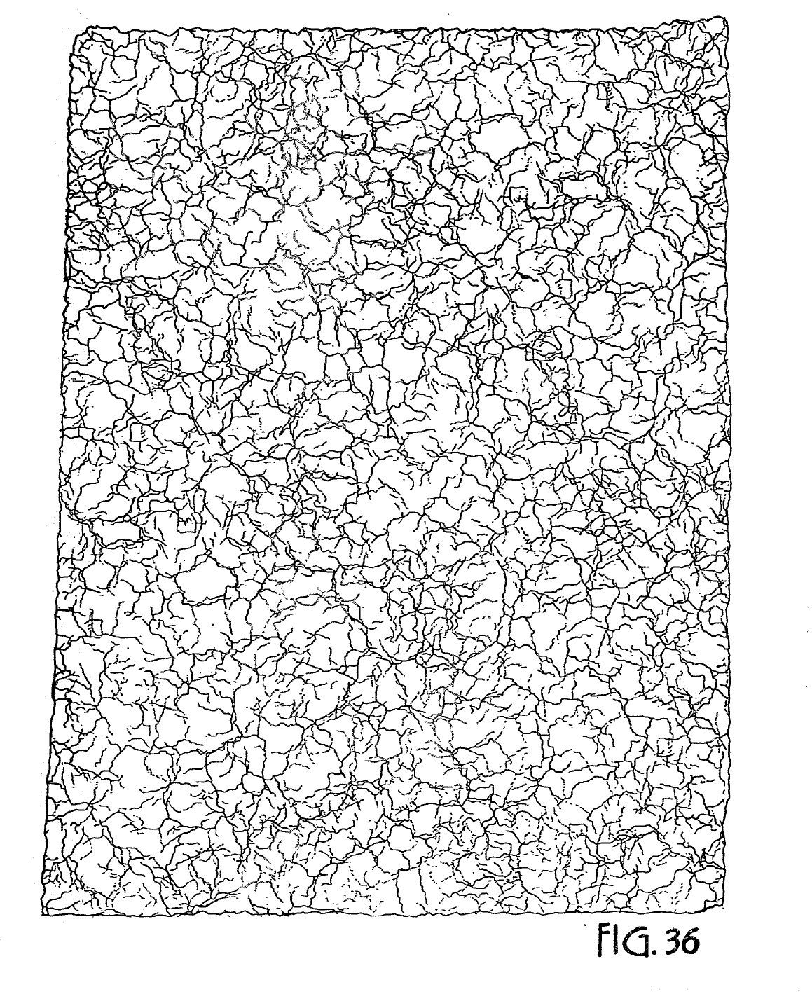

A hairline crackle stamp is illustrated at 90 in FIG. 33, and has hairline (narrow) raised ribs 92 arranged on the periphery as shown in FIG. 33. The pattern 94 is illustrated in FIG. 34, and the hairline pattern stamp shown in FIG. 36 illustrates a wall surface or panel that has been stamped with stamp pad 90. The same hairline crackle stamp pattern utilizing the stamp of 90 of FIG. 33, can be used in different orientation, including a double application of the print images. Hairline crack forming ribs are generally as narrow as possible, usually in the range of 1/64 inches.

The hairline stamps are generally used in projects that are small, such as plaques, pictures or stationary. It imitates crackle you would find in an old oil painting or the paint had been sprayed on a surface very thinly and over time is weathered and cracked in a fine line pattern.

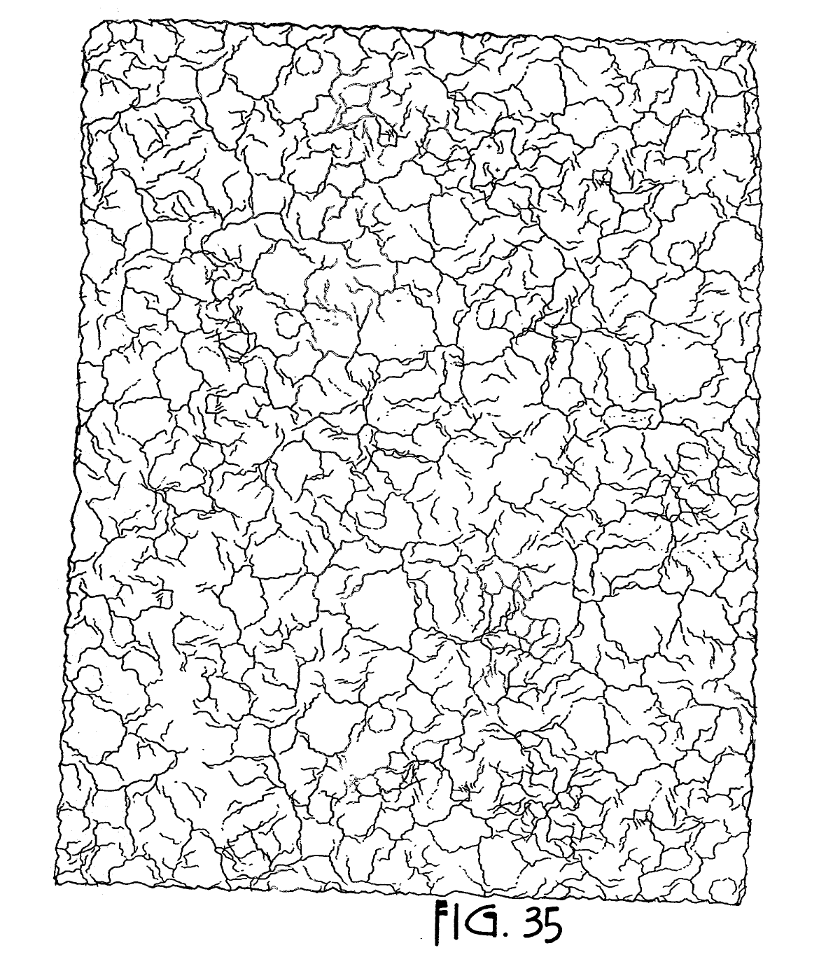

Thus, by utilizing the concave and convex portions, and interfitting the images when they are printed, the stamp or printing pads of the present invention permit a user to provide printed or painted configurations on a wall or other surface without any visible lines between individually printed or applied pad images. The use of the narrow fingers out near the edges is an aid, and in some instances, as pointed out the ribs terminate inwardly from the actual edge of the pad wall so that when visually doing the application, the pad wall edge can be overlapped over the previous image. This then will provide a continuous crackle surface as illustrated in FIG. 35.

Although the present invention has been described with reference to preferred embodiments, workers skilled in the art will recognize that changes may be made in form and detail without departing from the spirit and scope of the invention.

What is claimed is:

1. A crackle finish printing pad comprising a flexible wall, and a plurality of elongated ribs raised from one surface of the wall and having narrow and elongated end surfaces lying on a common plane.

2. The printing pad of claim 1, wherein said ribs range down to 1/64 of an inch in width, and have lengths up to the range of about 3 inches.

3. The printing pad of claim 1, wherein said ribs are curved, and extend in directions that change along the length of the ribs.

4. The printing pad of claim 3, wherein said ribs include narrow fingers extending laterally from main portions of the ribs in selected places.

5. The printing pad of claim 1, wherein said pad has peripheral edges that are contoured, and include at least some concave edge portions and convex edge portions that are designed to interfit together when the printing pads are used for printing multiple times on a same surface.

6. The printing pad of claim 5, wherein said printing pad has four corners defining the periphery, with concave portions between the corners.

7. The printing pad of claim 6, wherein said ribs comprise main ribs and lateral ribs, and said main ribs run generally parallel to each other along a first dimension of the printing pad, and lateral ribs extending laterally substantially less than the length of the main ribs, and at least some of the lateral ribs joining the main ribs.

8. The printing pad of claim 5, wherein said printing pad in elongated in a first direction, and is narrower in a second direction, the pad having a generally concave edge between a pair of corners defining side of the pad in the elongated direction.

9. The printing pad of claim 5, wherein said pad has convex portions along an edge opposite from the concave edge, and includes additional concave portions along the convex edge.

10. The printing pad of claim 5, wherein said pad is generally crescent shaped having a convex side and a concave side.

11. The printing pad of claim 10, wherein said pad ribs include main ribs that are wider adjacent the convex side, and further include laterally extending ribs going toward the concave edge.

12. The printing pad of claim 11, wherein said main ribs form wider imprints than the laterally extending ribs, and the wider imprints form generally crescent shaped images when imprinted on a surface, said crescent shapes being joinable at end points thereof with additional imprints from the printing pad oriented in an inverted position.

13. The printing pad of claim 1, wherein said printing pad comprises a secondary printing pad used for filling in voids when a larger printing pad is used for printing on a surface.

14. The printing pad of claim 1, wherein said pad is elongated substantially more than its lateral dimension, and the ribs form irregular representations resembling lighting bolts when printing on a surface.

15. The printing pad of claim 1, wherein said pad wall has a plurality of upright handles that are separated into individual handle segments on a side of the pad opposite from the ribs.

16. A method of faux pain ting to simulate a crackle finish comprising providing a support having a support surface with a plurality of thin ribs supported on the surface, the ribs having outer end surfaces, and extending non symmetrically along the support surface, the support having a defined periphery encompassing the ribs to form a rib pattern, applying a printable substance to the end surfaces of the ribs, first applying the support to a substrate to imprint the image of the ribs onto the substrate to leave the rib image in place on the substrate, applying a second rib image on the substrate with a support having a rib pattern which interfits with the first applied image to provide an impression of a crackle finish.

17. The method of claim 16, including applying a plurality of images in sequence on the surface using the support, and extending the images across the surface in a pattern of randomly positioned lines forming a crackle surface.

18. The method of claim 16, and providing a second smaller size support and filling in print voids on the substrate when the first mentioned support has been used across the surface.

19. The method of claim 16, wherein the support comprises a pad having the ribs arranged in a generally crescent shape, and orienting the pad so that points of the crescent on the first printing are engaged by points on the crescent of the second printing with the crescent shape facing in an opposite direction.

20. A method of faux painting crackle finishes comprising the steps of providing a pad having a surface, said surface supporting a plurality of ribs configured to be of size and shape to simulate a cracked surface, and forming the ribs to have a configuration desired for the crackle finish, said pad having a peripheral edge on at least two sides that includes concave portions, and having convex portions that complement concave portions, and printing at least two images including a first image, and a second image oriented so the convex portion of the image from the pad is nested in a concave portion of the first image applied to the surface.
